(19) United States
(12) Patent Application Publication
(10) Pub. No.: US 2022/0092701 A1
(43) Pub. Date: Mar. 24, 2022

(54) METHOD FOR AUTOMATED DRIVER INSURANCE RISK ASSESSMENT

(71) Applicant: GO2SOLUTION HOLDING LTD, VADUZ (LI)

(72) Inventors: OLEG KOROL, Ashdod (IL); GENADI MAN, Oberwil (CH)

(21) Appl. No.: 17/493,270

(22) Filed: Oct. 4, 2021

Related U.S. Application Data
(60) Provisional application No. 63/066,276, filed on Aug. 16, 2020.

(51) Int. Cl. G06Q 40/08

(52) U.S. Cl. CPC G06Q 40/08

(57) ABSTRACT

A method of continuous auto insurance risk scoring based on receiving the insured's cellphone GPS location data from which the itinerary of travel is determined, as well as speed which is compared to speed limits.

The distance traveled per day and per month is compared with the insured's respective averages. Road Risk is assessed based on frequency of accidents for the roads traveled, weather and time of day. Personal Risk score is also determined based on number of trips unclassified or disputed as to who the driver was or claims that the cellphone was used by someone else, as well as willingness to follow suggestions for lowering the risk profile.

### CROSS-REFERENCE TO RELATED APPLICATIONS

The present application claims the benefits of and priority, under 35 U.S.C. § 119(e), to U.S. Provisional Application Ser. No. 63/066,276, filed on Aug. 16, 2020, entitled “METHOD FOR AUTOMATED DRIVER INSURANCE RISK ASSESSMENT”. The entire disclosure of the application listed above is hereby incorporated by reference, in its entirety, for all that it teaches and for all purposes.

### BACKGROUND OF THE INVENTION

This invention relates to Automated Driver Insurance Risk Assessment Methods particularly to such Methods based on Cellphone Geo-Location Data.

There is a number of types of automated insurance methods for the underwriting process with real time risk adjustment which also incorporate machine learning features. One example of such prior art is the European Patent Application EP16731868 for Life Insurance System with fully automated real time underwriting process and risk adjustment. In this application proposed are an automated, distinct triage or channel-based automated mortality classification and measuring system and a method for the automated assessment, measurement, and monitoring of life risks, wherein life risks associated with risk-exposed individuals are transferable to a first insurance system and/or from the first insurance system to an associated second insurance system. The system comprises a table with retrievable stored risk classes each comprising assigned, triggerable risk class criteria. Individual-specific parameters of the risk-exposed individuals are captured relating to criteria of the stored risk classes and a specific risk class associated with the risk of the exposed individual. Thus, this is an actuarial type system, which is table driven, which doesn't conduct individual's continued risk assessment based on their ongoing conduct in real time.

Another representative prior art which is directly relevant to the subject of present invention is the Application WO2018028799 for a Telematics System with vehicle embedded telematics devices for score driven automated risk assessment and underwriting. This patent application describes the telematics-based system which comprises vehicle-embedded telematics devices which have a wireless connection to a central, expert system-based circuit. The telematics devices are connected via interfaces to the sensors and measuring devices and/or an on-board diagnostic system and an in-car interactive device wherein the telematics devices capture usage-based, vehicle and driver-based telematics data. This patent application offers a limited solution which relies on specialized telematics means instead of the common cellphone and lacks the scope of the solution that we intend to proffer.

Another relevant exemplar of prior art is US20130046559 which teaches system and method for computing and scoring the complexity of a vehicle trip using geo-spatial information. This patent while offering some useful functionality which compares to a small part of our proposed system, doesn't amount to an automated driver/vehicle/road risk assessment system and thus doesn't measure up to the stated intent of our proposed solution.

Still another relevant exemplar of prior art is US20130096731—that teaches Drive Event capturing based on geolocation. Likewise, this patent while offering some useful functionality which compares to a small part of our proposed system, doesn't amount to an automated driver/vehicle/road risk assessment system and thus doesn't measure up to the stated intent of our proposed solution.

In light of the foregoing we conclude that the prior art and its underlying concepts are clearly inadequate and require a new solution for the problems said prior art seeks to resolve.

### SUMMARY OF THE INVENTION

The present invention provides a method for auto insurance of continuous, ongoing during policy term, Driving and Roads risk assessment, a method for auto insurance of continuous, ongoing during policy term, risk assessment related to the insured's Personal Reliability, and a method for auto insurance of continuous, ongoing during policy term, risk assessment score.

One object of the present invention is to provide a method for scoring for auto insurance underwriting the data related to insured current diving behavior in real time.

Another object of the present invention is to provide a method for scoring for auto insurance underwriting the data related to insured current road conditions in real time.

Another object of the present invention is to provide a method for scoring personal reliability of the insured's.

Another object of the present invention is to provide a method for scoring for auto insurance underwriting the data related to insured current health and psychological conditions based on data which is continuously updated.

### BRIEF DESCRIPTION OF THE DRAWINGS

FIG. 1 shows Driving and Road scoring factors.

FIG. 2 shows Personal Reliability scoring factors.

### DETAILED DESCRIPTION

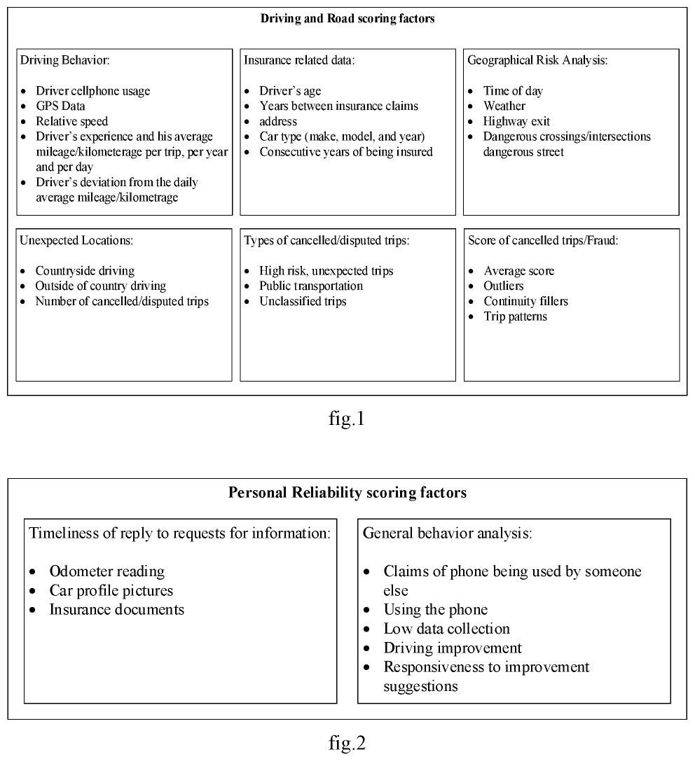

The method of risk assessment of the present invention is based on risk assessment being continuous throughout the current insurance term and is done per each trip and per month. The method for risk assessment is based on scoring risk factors which can be divided into 2 main groupings: Driving and Road Scoring (FIG. 1) and Personal Reliability Scoring (FIG. 2).

Driving and Road Scoring comprises the following assessment areas for which scoring is generated:

Driving Behavior scored based on: driver cellphone usage of any kind while driving; GPS Data which allows determination of speed, distance traveled and trip itinerary; speed relative to other traffic on the same roads and relative to posted speed limits; driver's experience and his average mileage/kilometerage per trip, per year and per day, and his deviation from the daily average mileage/kilometrage;

Insurance related data: driver's age, years between insurance claims, address, car type (make, model, and year), consecutive years of being insured;

Geographical Risk Analysis: time of day, weather, highway exit, dangerous crossings/intersections, dangerous street;

Unexpected Locations: countryside driving, car racing tracks/known drag racing locations, outside of country driving; number of cancelled/disputed trips: trips claimed as bus rides, trips claimed as taxi rides, trips claimed as not being the driver, unclassified trips (no knowledge as to the insured person being the driver), low score trips (trips for which the danger level is high);

Types of cancelled/disputed trips: high risk, unexpected trips (trips which are outside of a normal pattern for this driver), public transportation, unclassified trips (see above);

Score of cancelled trips/Fraud: average score (monitoring the average score of the driver), outliers (if a score of a given trip is much higher or much lower than the average, then this is an outlier), continuity fillers (odometer reading minus the total distance of classified trips—the difference is applied to unclassified/disputed trips), trip patterns (when trip patterns are inconsistent or inexplicable or hard to establish).

Personal Reliability Scoring is based on the following criteria:

Timeliness of reply to requests for information such as: odometer reading (upon request photo of odometer needs to be provided), car profile pictures, insurance documents (personal ID, no claim certificate etc);

General behavior analysis: claims of phone being used by someone else, using the phone (any activity using the phone; calling, using apps), low data collection (unable to collect data about a person), driving improvement (average trip score is improving), responsiveness to improvement suggestions (willingness to follow suggested ways to improve trip scores).

Optional: Health and Personal Psychological Condition scoring. Changes in health related to driving ability are factored in for scoring; they include any impairment of the reaction time such as due to prescribed medications causing drowsiness or inattentiveness for the prescription's duration of treatment, changes related to physical health such as the driver being in pain and/or under influence of pain relieving medications as an example after surgery or dental treatment and other pertinent changes in physical health affecting insured's driving ability. Also factored in are changes in the driver's psychological condition whether they are positive or negative; for example, being informed about a cancer diagnosis could certainly interfere with one's driving ability, likewise receiving the news of a job loss, major lawsuit, divorce or criminal indictment filed against the driver, or news of death/serious illness/injury of close relative will drastically decrease their attention and lengthen their reaction time. Likewise, any truly major events in the lives of the insured's closest relatives whether positive or negative affect the insured's psychological condition, which can optionally be also used for risk scoring in much the same way major positive news also have the ability to cause a euphoric reaction and inattentiveness; such as getting a big contract for a businessman, job promotion or raise for an employee, winning a lawsuit or getting married. Of course, any available information indicating the use of illegal drugs is to be treated as a continuous scoring factor or as grounds for terminating coverage.

This data can be obtained from insured's current medical info files, governmental organizations (for legal matters, marriage/divorce), obtained with permission from insured's employer, from social networks or be self-reported. Optionally the insureds can be provided with plug-in olfactory sensors, for detecting the alcohol smell and its concentration inside the vehicle and use that data for scoring as well.

In operation of the method of the present invention there is a continuous scoring adding or subtracting a predetermined number of points for each present situation or set of circumstances during each trip using the Driving and Road Scoring criteria as described whereby a score is determined for each trip as well as updated for each predetermined time periods such as for example day, week and month.

Driving Behavior is scored based on driver cellphone usage of any kind while driving; GPS Data which allows determination of speed, distance traveled and trip itinerary that in turn allows the use of other Driving Behavior criteria such as; vehicle speed relative to other traffic on the same roads and relative to posted speed limits, obeying Stop Signs, other Signs and Traffic Lights.

Driver's experience and their average mileage/kilometerage per trip, per year, per month and per day, and his deviation from the daily average mileage/kilometerage are continuously updated while driving. The kilometerage/mileage per trip is determined based on the starting and ending points of the trip excluding intermediate stops at gas stations, rest areas and roadside convenience stores. Machine-learning algorithms may be used to better determine the actual length of the trip and may include stop duration under or beyond a predetermined duration for the determination of individual trip beginning—end and the beginning of next trip, as well as possibly based on the destination specified in the Driving Directions App.

Geographical Risk Analysis is also conducted while driving and includes Time of Day, Weather, Highway exit, Dangerous crossings/intersections, and dangerous street. It may also factor in temporary anomalous events in a specific location; such as flush floods, earthquakes, large forest or urban fires, demonstrations, mass gatherings of people and riots.

Unexpected Locations are also factored in for scoring: countryside driving for urban dwellers or urban driving for countryside residents, entry of car racing tracks/known drag racing locations, outside of country driving, especially for non-European countries where that is unusual.

Scoring processing (for example, via one or more processors) related to trips classification doesn't have to be conducted when driving. Said processing factors in; number of cancelled/disputed trips: trips claimed as bus rides, trips claimed as taxi rides, trips claimed as not being the driver, unclassified trips (no knowledge or certainty as to the insured person being the driver), low score trips (trips for which the danger level is high based on the above referenced criteria).

Different scoring is applied to different Types of cancelled/disputed trips: high risk, unexpected trips (trips which are outside of a normal pattern for this driver), public transportation, unclassified trips (see above);

Score is calculated for cancelled trips to detect Fraud: Average Score—monitoring the average score of the driver, taking into account the Outliers; if a score of a given trip is much higher or much lower than the average, then this is an outlier for which special scoring is applied, Continuity Fillers are applied for odometer reading minus the total distance of classified trips—the difference is applied to unclassified/disputed trips, Trip Patterns are also factored in for the above Score—when trip patterns are inconsistent or inexplicable or hard to establish.

Personal Reliability Scoring is conducted based on the following criteria:

Timeliness of reply to requests for information such as: Odometer reading—upon request photo of odometer needs to be timely provided, Car profile pictures, Insurance documents (personal ID, no claim certificate etc.).

General behavior analysis is conducted; Claims of phone being used by someone else, using the phone (any activity during driving using the phone; calling, using apps), low data collection (unable to collect data about a person), driving improvement (average trip score is improving), responsiveness to improvement suggestions (willingness to follow suggested ways to improve trip scores).

Optional: Health and Personal Psychological Condition scoring. Changes in Health related to driving ability are factored in for scoring; they include any impairment of the reaction time such as due to prescribed medications causing drowsiness or inattentiveness for the prescription's duration of treatment, changes related to physical health such as the driver being in pain and/or under influence of pain relieving medications as an example after surgery or dental treatment and other pertinent changes in physical health affecting insured's driving ability. Also factored in are changes in the driver's psychological condition whether they are positive or negative; for example, being informed about a cancer diagnosis could certainly interfere with one's driving ability, likewise receiving the news of a job loss, major lawsuit, divorce or criminal indictment filed against the driver, or news of death/serious illness/injury of close relative will drastically decrease their attention and lengthen their reaction time. Major positive news also have the ability to cause a euphoric reaction and inattentiveness; such as getting a big contract for a businessman, job promotion or raise for an employee, winning a lawsuit or getting married. Of course, any available information indicating the use of illegal drugs is to be treated as a continuous scoring factor or as grounds for terminating coverage.

This data can be obtained from insured's current medical info files, governmental organizations (for legal matters, marriage/divorce), obtained with permission from insured's employer, from social networks or be self-reported.

The above scoring also factors in the General Insurance Information about the insured driver: Driver's Age, Years of driving experience, Years between Insurance Claims, Address, Car Type (make, model and year), Consecutive years of being insured including separately the years of being insured by the current auto insurance company.

In an effort to provide a concise description of the embodiments, not all features of an actual implementation are described in the specification. The invention is not limited to any embodiment. The invention encompasses numerous alternatives, modifications and equivalents. Numerous specific details are provided for the purpose of example and the invention may be practiced according to the claims without some or all of these specific details. It should be appreciated that such a development effort might be complex and time consuming, but would nevertheless be a routine undertaking of design and implementation for those of ordinary skill having the benefit of this disclosure.

What claimed is:

1. A method for auto insurance of continuous, ongoing during policy term, Driving and Roads risk assessment comprising the steps of:
receiving and recording insured's cellphone GPS location data,
processing said GPS data for the purposes of determining insured's itinerary of movement, said movement's speed and distance traveled,
using the information obtained from the above steps for Risk scoring.

2. The method of claim 1, further comprising the step of:
detecting any cellphone usage by the insured while the vehicle is in motion,
using the information obtained from the above step for Risk scoring.

3. The method of claim 1, further comprising the step of:
processing said GPS data for the purposes of determining insured's itinerary of movement and distance traveled,
using the information obtained from the above steps for Risk scoring.

4. The method of claim 1, further comprising the step of:
comparing the speed of travel to the speed limits on streets and roads that the insured is traversing,
using the information obtained from the above steps for Risk scoring.

5. The method of claim 1, further comprising the step of:
comparing the speed of travel to the speed of other traffic on the same streets and roads,
using the information obtained from the above steps for Risk scoring.

6. The method of claim 1, further comprising the step of:
determining and updating the insured's usual trip itinerary patterns,
comparing the current trip itinerary with the usual trip patterns for the insured to detect unusual pattern deviation,
using the information obtained from the above steps for Risk scoring.

7. The method of claim 1, further comprising the steps of:
determining and updating Average distance traveled per trip and per predetermined at least one time period,
comparing Said Average Distance are compared with distance traveled on current trip and/or over predetermined at least one time period,
driving Risk Scoring is performed on the basis of deviation from average distance traveled per trip or per predetermined time period.

8. The method of claim 1, further comprising the step of:
obtaining the frequency of accidents data for geographical location traveled through,
using the data obtained from the preceding step for Risk Scoring.

9. The method of claim 1, further comprising the steps of:
obtaining weather data for locations traveled through,
recording time of day when traveling in a given geographical location,
using the data obtained from the preceding steps for Risk Scoring.

10. The method of claim 1, further comprising the steps of:
determining if locations traveled through are new or unusual for the insured,
using the data obtained from the preceding steps for Risk Scoring.

11. A method for auto insurance of continuous, ongoing during policy term, risk assessment related to the insured's Personal Reliability comprising the steps of:
determining and updating the average timeliness of responses to requests for information updates,
comparing said current timeliness with the insured's average timeliness and with the average timeliness of other insureds,
using the data obtained from the preceding steps for Risk Scoring.

12. The method of claim 11, further comprising the steps of;
totaling the number of unclassified trips per month,
updating the average of unclassified trips per month,
deviation from said average of unclassified trips is determined for current month,
using the data obtained from this step for Risk Scoring.

13. The method of claim 11, further comprising the steps of;
number of disputed trips per month is totaled,
average of disputed trips per month updated,
deviation from said average of disputed trips is determined for current month,
using the data obtained from this step for Risk Scoring.

14. The method of claim 11, further comprising the steps of;
number of disputed instances of phone usage per month is totaled,
average of disputed instances of phone usage per month updated,
deviation from said average of disputed instances of phone usage rips is determined for current month,
using the data obtained from this step for Personal Reliability Risk Scoring.

15. A method for auto insurance of continuous, ongoing during policy term, risk assessment score comprising the step of:
updating overall policy risk assessment by means of combining Driving and Roads risk score and Personal Reliability risk score, while giving each said score a predetermined weighting in the overall score.
